(19) United States
(12) Patent Application Publication
(10) Pub. No.: US 2026/0037000 A1
(43) Pub. Date: Feb. 5, 2026

(54) SYSTEM AND METHODS FOR CONTROL OF CANOPY FORMATIONS

(71) Applicant: U.S. Army DEVCOM, Army Research Laboratory, Adelphi, MD (US)

(72) Inventor: Mahdi Al-Husseini, Enterprise, AL (US)

(73) Assignee: U.S. Government, as Represented by Secretary of the Army, Adelphi, MD (US)

(21) Appl. No.: 18/793,998

(22) Filed: Aug. 5, 2024

(51) Int. Cl. G05D 1/654; B64D 47/06; B64U 10/13; B64U 101/30; G05D 1/686; G05D 105/80

(52) U.S. Cl. CPC G05D 1/654; B64D 47/06; G05D 1/686; B64U 10/13; B64U 2101/30; B64U 2201/20; G05D 2105/80

(57) ABSTRACT

Various embodiments are directed to systems, apparatus and methods for controlling canopy formations approaching a desired impact point (DIP) such as by maintaining a preset offset distance in front of and below a lead parachutist while navigating toward the DIP along a prescribed route. The UAS may operate independently with upload of a pre-planned routing structure or be controlled by a remote control site with access to environmental data, maps, and surveillance footage.

### GOVERNMENT INTEREST

The invention described herein may be manufactured and used by or for the Government of the United States for all governmental purposes without the payment of any royalty.

### FIELD OF THE DISCLOSURE

The present disclosure relates generally to canopy formation control, and more particularly to systems employing strategic control of unmanned autonomous systems (UAS) to guide a canopy formation to its desired impact point (DIP) in unfamiliar or hostile environments.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Parachute canopy formation flight involves the organized assembly and movement of parachutists under canopy in proximity. The practice of establishing these canopy formations is typically known as canopy relative work and is of interest to both competitive skydivers and military freefall teams.

Free fall parachutists exit an aircraft within seconds of one another and regroup while in freefall or following canopy deployment. Free fall operations in which canopy deployment occurs at high altitudes are known as High Altitude High Opening (HAHO) operations, or standoffs. Standoffs are tactically significant in that they permit free fall parachutists to exit the aircraft upwards of tens of kilometers from the desired impact point (DIP), which may allow the aircraft to remain beyond the air defenses of the enemy to ensure secrecy of the operation. The free fall parachutist team then navigates in formation under canopy through the sphere of enemy air defenses until arriving at the DIP to continue follow-on operations on the ground.

### SUMMARY OF THE INVENTION

Various deficiencies in the prior art are addressed below by the disclosed systems and method for a system configured to control one or more unmanned autonomous systems (UASs) deployed under canopy to provide navigational guidance to a grouped free fall team through hostile enemy airspace and to a DIP, such as by maintaining a preset offset distance in front of and below a lead parachutist while navigating toward the DIP along a prescribed route. The UAS may operate independently with upload of a pre-planned routing structure or be controlled by a remote control site with access to environmental data, maps, and surveillance footage.

Advantageously, the integration of UAS into tactical free fall operations greatly enhances stealth insertion capabilities and provides alternative means of command and control of free fall operations. Further, the various embodiments reduce cognitive load on free fall parachutists operating in hostile airspaces, increase the likelihood of success of a clandestine insertion, and provide free fall teams with remote and dynamic guidance from a control site.

A method according to an embodiment for controlling canopy formations approaching a desired impact point (DIP) may comprise, at an unmanned autonomous systems (UAS) deployed under canopy: establishing an in-flight offset distance between the UA and a lead parachutist of a stack of parachutists under canopy; navigating through airspace toward a desired impact point (DIP) in accordance with routing instructions stored in the UAS while maintaining the established offset distance; and transmitting, toward a glide data unit (GDU) associated with the lead parachutist under canopy, data configured to be presented via a display device operatively coupled to the GDU, the data representing at least one of routing, approach, DIP landing information, and environmental data.

A system according to an embodiment for controlling canopy formations approaching a desired impact point (DIP) may comprise: at least one unmanned autonomous systems (UAS) configured for deployment under canopy and configured to fly in front of a stack of parachutists under canopy, the UAS comprising: a non-transitory memory, for storing computer instructions and navigation routing data; a distance sensor, for determining a vertical and lateral distance from a lead parachutist under canopy; and a transceiver, for communicating with a glide data unit (GDU) associated with a lead parachutist under canopy; and a lead parachutist GDU configured for deployment under canopy with a lead parachutist, the GDU comprising: a transceiver, for communicating with the at least one UAS; and a display, for displaying information received from the at least one UAS, the displayed information being configured to represent for the canopy flight at least one of routing, approach, and DIP landing information.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a block diagram of a system for controlling canopy formations in accordance with an embodiment.

FIG. 2 depicts a flow diagram of a method of controlling canopy formations in accordance with an embodiment;

FIG. 3 graphically illustrates a canopy formation controlled in accordance with an embodiment.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments, such as seismology and data fusion.

Military free fall operations permit stealthy and efficient infiltration into enemy territory. Unlike civilian skydiving where there is significant familiarity with the utilized drop zone, the desired impact point (DIP) in free fall operations is presumed to be hostile ground and is likely known only through limited reconnaissance; conditions in and around the DIP may be unreliable and dynamic in nature. Additionally, free fall operations are typically conducted during nighttime conditions and with the support of infrared systems and lighting. A military free fall team's ability to land in a consolidated manner on target while evading enemy air defenses is of upmost importance to follow-on mission success.

Although mission dependent, it is typically preferred for a free fall parachutist team to land off-DIP together than some members on the DIP while others land off. The ability to land at a desired on-ground target is a combination of recognizing and adjusting for environmental factors like wind and canopy control techniques. Precision landings are more complicated when an entire canopy formation must land on target while stacking (one parachuter above and behind the other), and when in enemy terrain that is only partially known.

Enemy air defenses are yet another critical consideration. Navigation through overlapping spheres of enemy air denial systems requires quality intelligence and significant pre-planning. Much as aircraft must do when navigating enemy air defenses, parachutists must navigate through a three-dimensional space of enemy threat with few (often noncontiguous) areas with freedom of maneuver. The free fall team must route their movement to the DIP accurately to avoid detection while also focusing on flying their canopies and remaining grouped. It is unsurprising then that the entire free fall team is under significant cognitive load throughout their movement from aircraft exit to DIP.

Various deficiencies in the prior art are addressed below by the disclosed systems and method for a system configured to control one or more unmanned autonomous systems (UASs) deployed under canopy to provide navigational guidance to a grouped free fall team through hostile enemy airspace and to a DIP. The UAS may operate independently with upload of a pre-planned routing structure or be controlled by a remote control site with access to environmental data, maps, and surveillance footage.

Advantageously, the integration of UAS into tactical free fall operations greatly enhances stealth insertion capabilities and provides alternative means of command and control of free fall operations. Further, the various embodiments reduce cognitive load on free fall parachutists operating in hostile airspaces, increase the likelihood of success of a clandestine insertion, and provide free fall teams with remote and dynamic guidance from a control site.

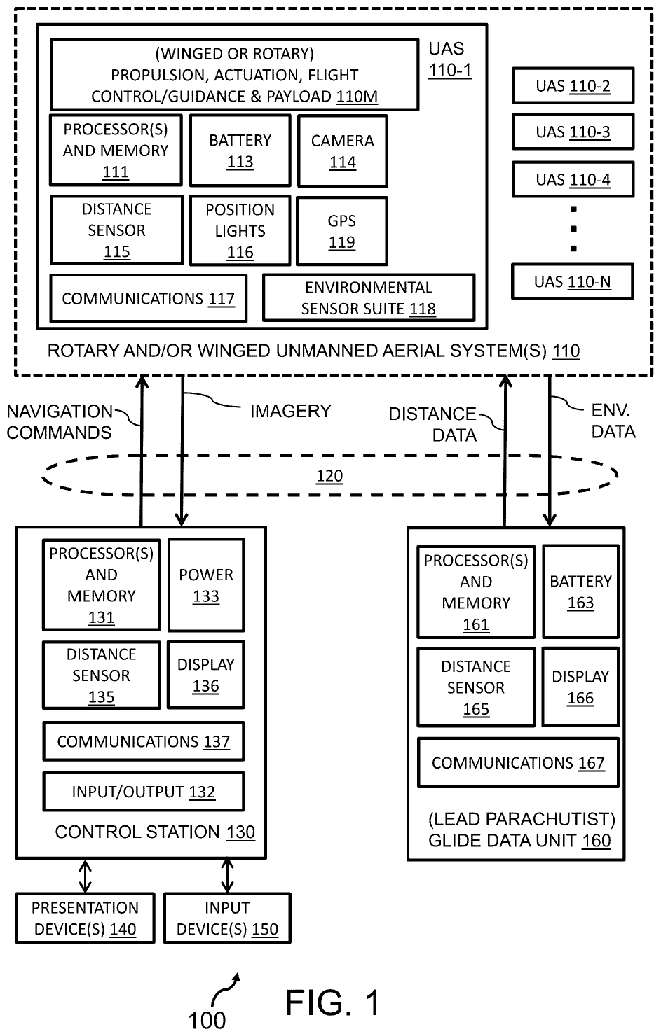

FIG. 1 depicts a block diagram of a system for controlling canopy formations in accordance with an embodiment. The canopy formations control system 100 of FIG. 1 comprises one or more data processing elements, computing devices, network elements and the like cooperating as described herein to implement various embodiments. Not all of the described data processing elements, computing devices, network elements, sensing devices and the like are necessary to implement each embodiment. The exemplary system described herein is provided for illustrative purposes only. Portions of the system 100 of FIG. 1 may be implemented via one or more servers, workstations, data centers, mobile devices, and/or other computing and memory providing devices operating in accordance with the various embodiments, such as described herein and with respect to the various other figures.

Specifically, FIG. 1 depicts a block diagram showing the components of an exemplary canopy formations control system 100 including at least one unmanned aerial system (UAS) 110 configured for persistent or intermittent wireless communication via a wireless channel or link 120 with a remote control station 130 and with at least one glide data unit (GDU) 160 associated with (e.g., carried by and under the control of) a parachutist within the canopy, illustratively a lead parachutist. In various embodiments one or more of the non-lead parachutists are associated with respective GDUs 160.

Generally speaking, the least one UAS 110 is configured for supporting canopy formations flights via modules comprising hardware or a combination of hardware and software configured to perform various control and communications function. For example, the various UAS control functions may include some or all of the following functional modules, which modules may be implemented via the processor/memory 111 and other relevant components of the UAS 110:
A guidance control and navigation module, configured to cause a deployed UAS to fly toward a target destination or DIP (or intermediate destinations or waypoints prior to the DIP) via a navigation route stored in UAS memory.
A position control module, configured to cause a deployed UAS to maintain a flight position with respect to a parachutist, such as at a predetermined distance in front of and below a lead parachutist as part of the stick of parachutists in the canopy formation.
An image capture module, configured for capturing relevant imagery while navigating towards the DIP and transmitting the imagery to a control station, glide data unit (GDU) of a lead parachutist and/or other parachutist in the canopy formation, or other receiver as appropriate.
An environmental data capture module, configured for capturing environmental data while navigating towards the DIP and providing the captured environmental data to the GDU of the lead parachutist and/or other parachutist in the canopy formation.
An operational update module, configured to receive control messages and the like from the control station and to responsively update operational, control, and other parameters (e.g., in response to updated navigation information, control commands, and the like).
Other control modules, configured to perform the various other functions described herein in accordance with the embodiments.

As depicted in FIG. 1, each of the at least one unmanned aerial systems (UASs) 110 comprises a winged or rotary UAS comprising respective propulsion, actuation, flight control/guidance and optionally payload modules 110M (generally not discussed herein, but configured to generate an appropriate amount of lift to remain controllably airborne while adjusting position to maintain a desired distance offset to the canopy formation while navigating toward a DIP or other flight terminus), which modules 110 are modified or augmented with various other modules/elements including one or more processors with memory 111 (e.g., a computing device), battery 113, camera(s) 114, distance sensor(s) 115, position light(s) 116, communications transceiver 117, environmental sensor suite 118, global positioning system (GPS) receiver 119, and so on.

The one or more processors with memory 111 may comprise processing resources such as processor and/or logic circuitry capable of processing digital information such as ASICs, GPUs, DPUs, and the like, as well memory resources such as volatile and/or non-volatile memory capable of storing data and computing instructions such as ROM, EPROM, EEPROM, flash memory, DRAM, and the like. Generally speaking, the processor/memory 111 includes processing resources configured to retrieve and execute programming instructions stored in memory resources such that the processor/memory 111 performs various functions as described herein with respect to the embodiments. The memory resources must be large enough to store collected inertial, altitude, and distance data, along with imagery and video, for a period no shorter than the length of a HAHO jump at maximum altitude, regardless of collection rate frequency.

Battery 113 may be an internal battery whose electrical specifications are designed to support various data recording system 110 subcomponents for a period no shorter than the length of a HAHO jump at maximum altitude.

Camera(s) 114 may include one or more cameras or other image capture devices positioned to capture still or moving surveillance imagery such as above and within the DIP environment or other places of interest. Camera(s) 114 need not necessarily operate in, or only in, the visual light spectrum, and may further allow for infrared thermography, to include short wavelength infrared (SWIR), medium wavelength infrared (MWIR), and long wavelength infrared (LWIR). Accessing the infrared spectrum is especially valuable during nighttime free fall operations, where infrared imaging may prove sufficient for object detection and orientation estimation, to allow continued use of the proposed invention throughout multiple mission profiles. Camera 114 may also integrate night vision light intensification, which amplifies existing visible light. All imagery collected is timestamped and stored in memory 111.

Distance sensors 115 may comprise Bluetooth triangulation or ultrasonic sensors configured to determine relative position to the lead parachutists as an input to the actuation control system which allows UAS platform 130 to maintain its distance offset.

Communications transceiver 117 may comprise one or more transceivers capable of receiving and transmitting data across a wireless communication network 120. The wireless communication network 120 may include, for example a wireless local area network (WLAN), wireless personal area network (WPAN), wireless metropolitan area network (WMAN), wireless wide area network (WWAN), satellite-based networks, Bluetooth, or any combination thereof.

Wireless communication network 120 allows UAS platform 110 to transmit, illustratively, aerial imagery to control station 130 via communications transceiver 117, and allows control station 130 to transmit control messages such as navigational commands to UAS platform 110, if so desired (e.g., thus overriding an autonomous scout role).

Wireless communication network 120, or a second communication network (not shown), allows UAS platform 110 to transmit environmental data to, illustratively, the lead parachutist guiding the stack through approach and landing via communications transceiver 167 of GDU 160, and allows the lead parachutist to submit distance sensor data such as collected via distance sensor 165 to UAS platform 110 for an additional stream of reference data. The lead or other parachutists are optionally provided with a display 166, potentially as a wearable, through which reference environmental data may be provided by UAS platform 110 while in flight (among other data/imagery). In some embodiments, the lead parachutist may receive environmental data from UAS platform 110 via an audio device (speaker instead of or in addition to display 166) such as an audible altimeter as used in civilian skydiving, or a haptic device (vibrating device instead of or in addition to display 166).

It is noted that UAS platform 110 should be visible to all parachutists in the stack throughout the canopy formation flight. Thus, in various embodiments, the UAS platform 110 is made visible as far away as 1,000 feet via position lights 116 are embedded into (or onto) the UAS, much as is required by aircraft registered with the FAA, to ensure visibility in flight. Position lights 116 may be any combination of visual or infrared lighting, depending on the mission profile. The lighting may also be positioned within or upon a UAS in a manner visible only to the rear of the UAS.

Environmental sensor suite 118 includes one or more of a temperature sensor, an anemometer for measuring wind speed and direction, an altimeter such as a radar altimeter, one or more photoelectric sensors for determining environmental illumination such as at the DIP, and/or other devices configured to sense/measure and store in memory various environmental conditions.

As an aside, it is noted that the various components discussed herein (battery, sensors, comms/display equipment, and so on) must be able to operate in extreme temperature conditions consistent with high-altitude jumps.

As depicted in FIG. 1, each of the at least one glide data units (GDUs) 160 comprises, illustratively, one or more processors with memory 161 (e.g., a computing device), battery 163, distance sensor 165, communications transceiver 167, and so on, each of which may be implemented in a manner substantially similar to that described above with respect to corresponding components of the UAS 110. As depicted in FIG. 1, each of the at least one GDUs 160 further comprises a display device 166, which may comprise a display only device configured to present visual information to the parachutist or, in some embodiments, a touch screen device configured to present visual information to the parachutist as well as accept input from the parachutist.

As depicted in FIG. 1, the wireless channel or link 120 may comprise any suitable wireless channel or link, such as via radio frequency (RF) communications, optical communications, and so on (e.g., 802.11x, WiMAX, 4G/LTE, 5G, and the like). The wireless channel or link 120 may include, for example, wireless local area network (WLAN), wireless personal area network (WPAN), wireless metropolitan area network (WMAN), wireless wide area network (WWAN), satellite-based networks, or any combination thereof.

As depicted in FIG. 1, the control station 130 comprises, illustratively, one or more processors with memory 131 (e.g., a computing device), power processing circuitry 133, distance sensor 135, optional display device 136, communications transceiver 137, input/output circuitry 132, and so on, each of which may be implemented in a manner substantially similar to that described above with respect to corresponding components of the UAS 110.

The input/output (I/O) resources or interface(s) 133 are configured to enable communication between the control station 130 and various presentation devices 140 and/or input devices 150 which may optionally be used in some embodiments. For example, the I/O resources or interface(s) 133 may be coupled to one or more presentation devices (PDs) 140 such as display devices suitable for use in displaying or presenting information to a user, one or more input devices (IDs) 150 such as touch screen or keypad input devices for enabling user input, and/or interfaces enabling communication between the control station 130 and other computing, networking, presentation or input/output devices (not shown).

Presentation devices 140 may include a display screen, a projector, a printer, one or more speakers, and the like, which may be used for displaying data, displaying video, playing audio, and the like, as well as various combinations thereof, an application programming interface (API) configured to support the presentation of data, and so on. The typical presentation interfaces associated with user devices, including the design and operation of such interfaces, will be understood by one skilled in the art.

Input devices (ID) 150 may include any user control devices suitable for use in enabling a local or remote user of the control station 130 to interact with the control station 130. For example, the input devices 150 may include touch screen based user controls, stylus-based user controls, a keyboard and/or mouse, voice-based user controls, and the like, as well as various combinations thereof. The typical user control interfaces of user devices, including the design and operation of such interfaces, will be understood by one skilled in the art.

Although primarily depicted and described as having specific types and arrangements of components, it will be appreciated that any other suitable types and/or arrangements of components may be used for UAS 110, wireless communications channel, link, or network 120, control station 130, GDU 160, and/or any portions thereof.

Specifically, various elements or portions thereof depicted in FIG. 1 and having functions described herein are implemented at least in part as computing devices having communications capabilities, including in support of the UAS 110, wireless communications channel, link, or network 120, control station 130, GDU 160, and/or any portions thereof. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using computing and/or networking equipment used to implement various functions, the equipment comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. The computing and/or networking equipment may also be used to provide some or all of the various other core network nodes or functions described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

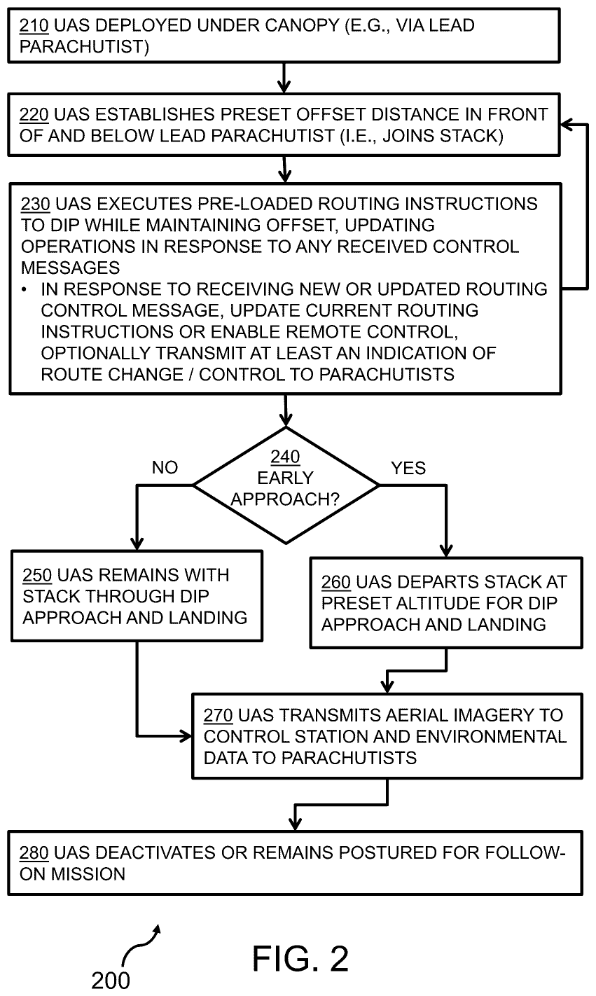

FIG. 2 depicts a flow diagram of a method of controlling canopy formations in accordance with an embodiment. The method 200 of FIG. 2 illustrates deployment and employment of a UAS with preloaded routing structure guiding a canopy formation through hostile airspace toward a DIP.

At step 210, the UAS is deployed under canopy by, illustratively, the lead parachutist of a stack. The altitude and timing of canopy deployment varies with mission requirements. The deployment 210 may comprising the lead parachutist unstowing the UAS, activating/powering the UAS (e.g., removing the UAS from an equipment pouch or Velcro strapped carrying case on the jumper's vest etc.), and deploying/releasing the UAS. Powering the UAS may comprise actuating a power switch and button and holding the UAS until a power-on and calibration sequence is complete. The lead jumper will likely require both hands to unstow and power UAS 130, and therefore may complete these steps following a typical canopy opening sequence but prior to unstowing toggles. Alternately, the unstowing and powering is automatically triggered based on altitude, predetermined amount of time since jump, and so on.

At step 210, the now deployed UAS adapts its flight to establish a preset offset distance in front of and below the lead parachutist, effectively joining the stack. It is noted that the lead parachutist is also known as the lower jumper or more colloquially as the low man and has control of the stack at lower altitudes once given to him or her by the higher jumper. The various embodiments are not limited to use by the lower jumper but positioning UAS ahead of the overall formation ensures safety through collision avoidance. The offset distance may be preprogrammed, preset ahead of the jump by the lead parachutist and may mirror typical distances between jumpers in a canopy formation, on the order of 50-100 feet laterally and horizontally. The UAS constantly adjust its actuators to maintain this offset, even as the lead parachutist dramatically changes forward speed and altitude throughout the flight.

At step 230, once established in position, the UAS executes pre-loaded or reconfigured routing instructions to navigate toward the DIP in a manner that avoids enemy weapon detection and engagement zones, all while maintaining an offset from the lead parachutists. Free fall operations in combat environments may very well occur at night, and it is critical that parachutists under canopy can easily spot UAS, such as via onboard visible or infrared lighting in some embodiments of the UAS. At any time, in response to the UAS receiving new or updated tasking or routing control messages, the current route is updated or recalculated as necessary, and an indication of an updated routing is transmitted to the parachutists. For example, a UAS deployed under canopy may response to control messages received from the remote control station by updating the routing instructions to modify thereby the navigating of the UAS through airspace by changing at least one of airspace routing, approach, and DIP, or to allow for remote control over the deployed UAS platform by the control station.

At step 240, a determination is made by the UAS as to whether an early approach is appropriate when the UAS is within a predefined distance from and/or altitude above the DIP.

If at step 240 the UAS is programmed or caused to execute an early approach, then at step 260 the UAS departs the stack in and accelerates towards the DIP, while at step 270 obtaining and transmitting to the control station (optionally the parachutists) various aerial images of the approaching DIP, various terrain features, enemy groupings/movements, and/or other items of interest, and obtaining and transmitting to the parachutists (optionally the control station) various environmental data. The benefits of the early approach involve reduced risk of an in-air collision during approach and landing, the provision of environmental data to the stack prior to approach and landing, and the provision of aerial imagery to the control station prior to final DIP selection. In this sense, UAS shifts from a guide to a scout-now responsible for collecting information about a DIP in enemy territory. Environmental data of note may include temperature, wind data, extent of illumination, and/or other information deemed useful to the mission. Wind data affects the approach direction of the canopy formation into the DIP, and illumination may affect actions after landing. Aerial imagery may inform the control station that the selected DIP is not suitable due to the presence of enemy threat or obstructed terrain.

The control station may then inform the canopy formation to move to an alternate DIP.

If at step 240 the UAS is not programmed or caused to execute an early approach, then at step 250 the UAS remains with the canopy formation through DIP approach and landing, while obtaining and transmitting imagery and environmental data as discussed above with respect to step 270.

At step 280, whether an early approach is executed or not, the UAS then deactivates or remains postured for follow-on mission requirements.

It is noted that the functions of steps 240-270 may be performed by a second UAS configured in a similar manner as the (first) UAS. For example, a second UAS may be deployed at the same time as a first UAS, where one of the two deployed UAS joins the stack (e.g., step 220) while the other UAS performs scouting of the terrain, airspace, DIP, enemy disposition, and the like to provide surveillance imagery and/or environmental data to the control station and/or GDU(s). Third and further UAS may also be deployed to assist with these functions. Alternatively, the second (or more) UAS may be deployed at a predefined altitude, or when the lead or other parachutist decides to deploy.

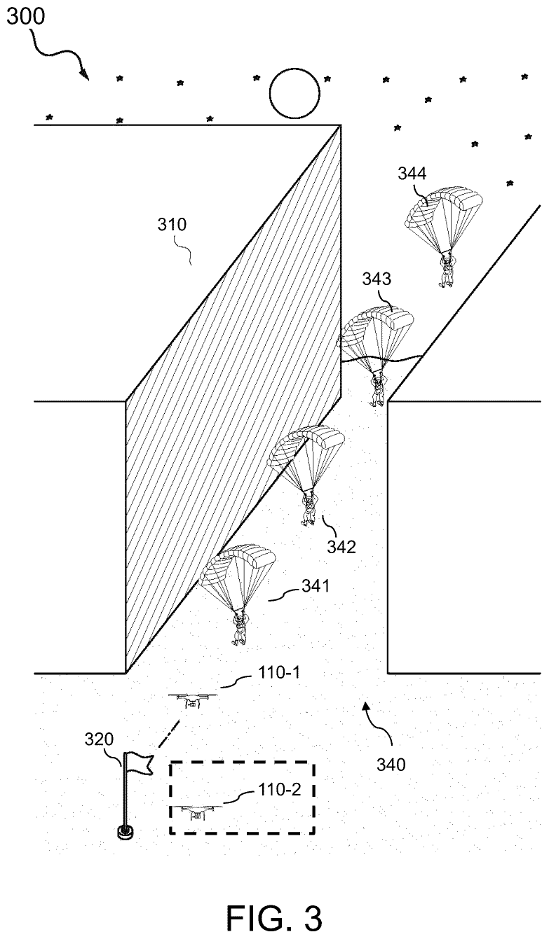

FIG. 3 graphically illustrates a canopy formation controlled in accordance with an embodiment. Specifically, FIG. 3 illustrates an exemplary operational of use of a system for control of canopy formations such as discussed above with respect to FIGS. 1-2 and the associated operating environment, to include the stacked free fall parachutist team under canopy, desired impact point, and detection and engagement zones of enemy airspace, in accordance with an embodiment of the present invention.

As depicted in FIG. 3, a stacked free fall parachutist team under canopy 340 (lead parachutist 340 and three other team members 342-344) descending/approaching a desired impact point (DIP) 320 by following a deployed UAS platform 110-1 while avoiding detection and engagement zones of enemy airspace 310. The UAS platform 110-1, illustratively a hand-held UAS platform of fixed wing or multi-rotor design, may be sized so as to allow deployment of the UAS 110-1 by hand once a jumper, typically the lead jumper 341, is under canopy. In various embodiments the UAS 110-1 comprises a multi-rotor platform since such a platform is well suited to capturing rapidly changing flight dynamics such as required of a system expected to maintain an offset distance from a jumper whose position may change rapidly based on canopy controls and environmental factors such as winds. The individual components of an exemplary handheld UAS platform 110-1 are discussed above with respect to the various figures.

Enemy weapon detection and engagement zones of enemy airspace 310 may be complex three-dimensional structures with multiple areas of overlap but also breakage. In various embodiments, the UAS platform 110-1 has stored within its memory enemy threat maps, optimal and backup routing through which to avoid detection and engagement, and so on as discussed above. The UAS platform 110-1 may be uploaded with such threat maps prior to mission execution; optimized routing may either be uploaded with the threat maps and/or generated/revised dynamically inflight as part of the UAS software package. The UAS platform 110-1 thusly configured is able to guide the stacked free fall parachutist team 340 through enemy airspace and to DIP 320.

FIG. 3 also depicts an optional second deployed UAS 110-2, which is configured to perform a reconnaissance, surveillance, and/or scouting function while the first UAS 110-1 continues to lead the stick of parachutists to the DIP 320. The second deployed UAS 110-2 may also operate as a backup to the first UAS 110-1 in the event of equipment failure or damage thereto. As depicted, the second UAS 110-2 has been deployed under canopy (via the lead or other parachutist) and it has accelerating towards the DIP 320 to begin transmitting toward a remote control station (or parachutist(s)) aerial imagery acquired by one or more image capture devices associated with the second UAS and environmental data acquired by one or more environmental sensors associated with the second UAS. Additional UAS 110 may also be deployed for various purposes.

Various embodiments provide a system for control of canopy formations through routing, approach, and landing at a desired impact point using UAS platforms, the system, comprising: one or more handheld UAS platforms deployable by a lead parachutist under canopy in a canopy formation, each handheld UAS platform possessing: embedded lighting for clear identification and tracking by the lead parachutist; memory for uploading navigational routing files; a transceiver through which to communicate with a lead parachutist digital device; a distance sensor capable of measuring vertical and lateral distance from the lead parachutist; the lead parachutist digital device, the device, comprising: a transceiver through which to communicate with one or more handheld UAS platforms; a display for providing the lead parachutist information received from one or more handheld UAS platforms regarding routing, approach, and landing at the desired impact point. The UAS platforms may be capable of operating upwards of 33,000 feet in support of high-altitude high-opening (HAHO) operations, and may be rotary, fixed wing, or any combination of the two. The embedded lighting may be in the visual spectrum for training and other non-tactical operations, or infrared spectrum for clandestine missions. The UAS platform(s) may further contain a transceiver through which to communicate with a remote control station, which itself contains a transceiver through which to communicate with the UAS platform(s). The lead parachutist digital device may further contain a distance sensor capable of measuring vertical and lateral distance from the UAS platforms, for purposes of verifying distance measurements. The UAS platforms may further contain one or more image capture systems for purposes of surveillance, with captured images stored in memory. The UAS platforms may further contain an environmental sensor suite to include an anemometer, radar altimeter, and temperature sensor.

Various embodiments provide a method for control of canopy formation through routing, approach, and landing at a desired impact point using one or more handheld UAS platforms, the method comprising: the lead parachutist under canopy deploying one or more UAS platforms; the deployed UAS platforms establishing a preset lateral and vertical distance offset from the lead parachutist in the canopy formation; the deployed UAS platforms executing a pre-loaded routing structure through airspace to approach and landing at the desired impact point while maintaining the established offset; the deployed UAS platforms transmitting to the lead parachutist information regarding routing, approach, and landing at the desired impact point. The deployed UAS platforms may be transmitting aerial imagery to a remote control station. In some embodiments, early termination of the distance offset is invoked to ensure the deployed UAS platforms have landed on the desired impact point prior to the canopy formation entering a typical landing pattern. Illumination of the UAS platforms may be provided to ensure visibility by at least the lead parachutist. The UAs may transmit environmental data to the lead parachutist. The deployed UAS platform, and not the lead parachutist, may undertake the responsibility of ensuring the distance offset condition is met. The remote control station may opt to override UAS preset or currently loaded/invoked routing instructions (e.g., by transmitting appropriate control messages to the UAS) to change the routing instructions or assert a manual or remote control over the deployed UAS platforms through airspace routing, approach, and landing at the desired impact point.

Various embodiments provide a method for confirming the suitability of a desired impact point prior to approach and landing using one or more handheld UAS platforms, the method comprising: the lead parachutist under canopy deploying one or more UAS platforms; the deployed UAS platforms moving away from the lead parachutist and towards the desired impact point; the deployed UAS platforms collecting aerial imagery and environmental data at the desired impact point; the deployed UAS platforms transmitting collected aerial imagery and environmental data to a remote control station in contact with the lead parachutist; the remote control station contacting the lead parachutist to instruct in-air diversion to an alternative desired impact point if the collected aerial imagery and environmental data suggests hostile or inhospitable conditions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A system for controlling canopy formations approaching a desired impact point (DIP) comprising:
at least one unmanned autonomous systems (UAS) configured for deployment under canopy and configured to fly in front of a stack of parachutists under canopy, the UAS comprising:
a non-transitory memory, for storing computer instructions and navigation routing data;
a distance sensor, for determining a vertical and lateral distance from a lead parachutist under canopy; and
a transceiver, for communicating with a glide data unit (GDU) associated with a lead parachutist under canopy; and
a lead parachutist GDU configured for deployment under canopy with a lead parachutist, the GDU comprising:
a transceiver, for communicating with the at least one UAS; and
a display, for displaying information received from the at least one UAS, the displayed information being configured to represent for the canopy flight at least one of routing, approach, and DIP landing information.

2. The system of claim 1, wherein the UAS further comprises embedded lighting, for enabling clear identification and tracking of the UAS by the lead parachutist.

3. The system of claim 2, wherein the embedded lighting comprises one of human visual spectrum lighting and infrared spectrum lighting.

4. The system of claim 1, wherein the at least one UAS is capable of operating upwards of 33,000 feet in support of high-altitude high-opening (HAHO) operations.

5. The system of claim 1, wherein each of the at least one UAS comprises one of a fixed wing UAS, a rotary UAS, and a combination fixed wing-rotary UAS.

6. The system of claim 1, further comprising:
a remote control station comprising a transceiver configured to communicate with the at least one UAS;
wherein each UAS further comprises a transceiver configured to communicate with the remote control station.

7. The system of claim 1, wherein the lead parachutist GDU further comprises a distance sensor configured to measure a vertical and lateral distance to the UAS.

8. The system of claim 6, wherein the UAS further comprises one or more cameras configured to capture still or moving surveillance images for storage in UAS memory.

9. The system of claim 8, wherein a deployed UAS is configured to transmit captured surveillance images to the remote control station.

10. The system of claim 1, wherein the UAS further comprises an environmental sensor suite configured to sense and capture environmental data for storage in UAS memory.

11. The system of claim 10, wherein the environmental sensor suite comprises at least one of an anemometer, a radar altimeter, and a temperature sensor.

12. The system of claim 10, wherein a deployed UAS is configured to transmit captured environmental data to the lead parachutist GDU for display thereat.

13. The system of claim 10, wherein a second deployed UAS under canopy is configured for accelerating towards the DIP, and transmitting toward a remote control station aerial imagery acquired by one or more image capture devices associated with the second UAS and environmental data acquired by one or more environmental sensors associated with the second UAS.

14. A method for controlling canopy formations approaching a desired impact point (DIP) comprising:
at an unmanned autonomous systems (UAS) deployed under canopy:
establishing an in-flight offset distance between the UA and a lead parachutist of a stack of parachutists under canopy;
navigating through airspace toward a desired impact point (DIP) in accordance with routing instructions stored in the UAS while maintaining the established offset distance; and
transmitting, toward a glide data unit (GDU) associated with the lead parachutist under canopy, data configured to be presented via a display device operatively coupled to the GDU, the data representing at least one of routing, approach, DIP landing information, and environmental data.

15. The method of claim 14, further comprising:
at the UAS deployed under canopy, transmitting, toward a remote control station, aerial imagery acquired by one or more image capture devices associated with the UAS.

16. The method of claim 14, further comprising:
at the UAS deployed under canopy, in response to the UAS determining that a predefined altitude has been reached, terminating maintenance of the in-flight offset distance between the UA and the lead parachutist, accelerating towards the DIP, and transmitting toward a remote control station aerial imagery acquired by one or more image capture devices associated with the UAS.

17. The method of claim 16, wherein the acquired aerial imagery comprises still or moving surveillance imagery of at least one of the approaching DIP, terrain features, enemy groupings, and enemy movements.

18. The method of claim 17, further comprising:
at the UAS deployed under canopy, transmitting toward the GDU associated with the lead parachutist under canopy, the acquired aerial imagery.

19. The method of claim 14, further comprising:
at a second UAS deployed under canopy, accelerating towards the DIP, and transmitting toward a remote control station aerial imagery acquired by one or more image capture devices associated with the second UAS and environmental data acquired by one or more environmental sensors associated with the second UAS.

20. The method of claim 14, further comprising:
at the UAS deployed under canopy, illuminating position lights of the UAS platform configured to improve visibility of the UAS to at least the lead parachutist.

21. The method of claim 14, further comprising:
at the UAS deployed under canopy, in response to control messages received from the remote control station, updating the routing instructions to modify thereby the navigating of the UAS through airspace by changing at least one of airspace routing, approach, and DIP.

22. The method of claim 14, wherein the environmental data comprises data provided by at least one of an anemometer, a radar altimeter, and a temperature sensor.
